(19) United States
(12) Patent Application Publication
(10) Pub. No.: US 2026/0044760 A1
(43) Pub. Date: Feb. 12, 2026

(54) METHOD AND SYSTEM FOR LEVERAGING LANGUAGE EMBEDDINGS FOR TIME SERIES TASKS

(71) Applicant: JPMorgan Chase Bank, N.A., New York, NY (US)

(72) Inventors: Rachneet KAUR, Manhattan, NY (US); Zhen ZENG, Ypsilanti, MI (US); Tucker Richard BALCH, Suwanee, GA (US); Manuela VELOSO, New York, NY (US)

(73) Assignee: JPMorgan Chase Bank, N.A., New York, NY (US)

(21) Appl. No.: 18/799,713

(22) Filed: Aug. 9, 2024

(51) Int. Cl. G06N 7/01; G06F 17/16

(52) U.S. Cl. CPC G06N 7/01; G06F 17/16

(57) ABSTRACT

A method and a system for leveraging language embeddings for time series tasks are provided. The method includes: receiving time series data; generating a standardized time series by formatting the time series data into a standard format; generating text embeddings from the standardized time series by transforming a sample of the standardized time series into an embedding; generating a combined representation by combining the generated text embeddings with the time series data; pairing a classification head framework with the combined representation; and generating a vector representation of time series probabilities based on the pairing of the combined representation with the classification head framework. The classification head framework includes a convolutional neural network (CNN) and a multilayer perceptron (MLP).

### BACKGROUND

### 1. Field of the Disclosure

This technology generally relates to methods and systems for leveraging language embeddings for time series tasks, and more particularly to methods and systems for utilizing a language embedding model to embed time series and then pairing the embeddings with a classification head for achieving high-performance and efficient time series classification.

### 2. Background Information

Time series classification has gained significant attention in recent years due to its wide-ranging applications in various domains, such as finance, healthcare, and activity recognition. The increasing availability of time series data has driven the need for efficient and accurate classification methods. Recent advancements in natural language processing (NLP) and large language models (LLMs) have shown strong promises in language modeling, particularly in capturing temporal dependencies within sequential data. Inspired by this success, researchers have explored extending these techniques to the time series domain by fine-tuning pre-trained LLMs, achieving state-of-the-art (SOTA) performance on well-established benchmarks for tasks including classification and forecasting.

Time series classification has been an active research area for decades. Early methods focused on distance-based approaches, such as Dynamic Time Warping (DTW) and distance kernels with Support Vector Machines (SVMs). Others extracted features and used linear or tree-based classifiers like eXtreme Gradient Boosting (XGBoost). Later, deep learning-based approaches, including Convolutional Neural Networks (CNNs), Multilayer Perceptron (MLP), and Recurrent Neural Networks (RNNs) like Long Short-Term Memory (LSTM), gained popularity. These models can learn complex patterns and handle long sequences. Recently, transformer-based models have been adapted from Natural Language Processing (NLP) to the time series domain. These models use self-attention mechanisms to model long-range dependencies. However, these more complex models often have larger sizes and higher computational costs, especially for training.

The success of language modeling in NLP and LLMs has inspired researchers to harness LLMs in the time series domain. Comprehensive surveys have offered valuable insights into the integration of LLMs in time series analysis, highlighting key methodologies, challenges, and future directions. Recent research has enabled pre-trained LLMs to generate time series forecasts through prompting. Further research has explored the potential of LLMs for generating explainable forecasts of financial time series. Additional research has introduced Time-LLM, which focuses on learning to project time series into the language embedding space and directly uses pre-trained LLMs for time series forecasting tasks. More importantly, recent models (e.g., OneFitsAll) have shown promising results by fine-tuning models like generative pre-trained transformer (GPT) on time series tasks. These models have achieved SOTA performance compared across various time series tasks including classification.

Text embeddings have played a crucial role in NLP. These embeddings map words or sentences into a dense vector space, capturing semantic and syntactic information. Various text embedding techniques have been proposed, ranging from word-level embeddings like Word2Vec and GloVe to contextualized embeddings obtained from pre-trained language models such as a Bidirectional Encoding Representations from Transformers (BERT) and a Robustly Optimized BERT Approach (RoBERTa). In the time series domain, some works have proposed unsupervised methods for learning time series embeddings. However, the availability of large-scale datasets in the time series domain is generally more limited compared to those in the NLP domain, making learning time series embedding from scratch more challenging compared to text embeddings.

However, the use of LLMs for time series classification comes with a significant drawback due to their large model size. These models often have billions of parameters, making them computationally expensive and limiting their usage in resource-constrained environments. At training time, fine-tuning partially frozen pre-trained LLMs often involves millions of trainable parameters.

Accordingly, there is a need for a mechanism for utilizing a language embedding model to embed time series and then pairing the embeddings with a classification head for achieving high performance and efficient time series classification.

### SUMMARY

The present disclosure, through one or more of its various aspects, embodiments, and/or specific features or sub-components, provides, inter alia, various systems, servers, devices, methods, media, programs, and platforms for utilizing a language embedding model to embed time series and then pairing the embeddings with a classification head for achieving high-performance and efficient time series classification. According to an aspect of the present disclosure, a method for leveraging language embeddings for time series tasks is provided. The method may be implemented by at least one processor. The method may include: receiving, by the at least one processor, time series data; generating, by the at least one processor, a standardized time series by formatting the time series data into a standard format; generating, by the at least one processor, text embeddings from the standardized time series by transforming a sample of the standardized time series into an embedding; generating, by the at least one processor, a combined representation by combining the generated text embeddings with the time series data; pairing, by the at least one processor, a classification head framework with the combined representation; and generating, by the at least one processor, a vector representation of time series probabilities based on the pairing of the combined representation with the classification head framework. The classification head framework may comprise a CNN and an MLP.

The generating of the text embeddings may comprise applying at least one of an artificial intelligence (AI) model and a machine learning (ML) model to embed the formatted time series into an embedding space. The transforming of the sample of the standardized time series into the embedding may be based on a dimension and a length of the sample of the standardized time series.

The method may further include identifying, by the at least one processor using the classification head framework and the at least one of the AI model and the ML model, a class label for each time series from within the time series data.

The combining of the generated text embeddings with the time series data may comprise applying an element-wise addition of the generated text embeddings with the time series data. Lengths of the generated text embeddings and lengths of the time series data may be aligned prior to the element-wise addition.

The pairing of the classification head framework with the combined representation may comprise pairing the CNN with the combined representation, flattening output from the pairing of the CNN with the combined representation, and then applying the MLP to the flattened output.

The formatting of the time series data may further comprise applying a digit-space tokenization method. The digit-space tokenization method may comprise spacing each digit of the time series data, adding commas to separate time steps, and removing decimal points.

The generating of the standardized time series may comprise normalizing the time series data within a range between zero (0.0) and one (1.0).

The classification head framework may identify and separate different classes of the time series data from within the combined representation.

According to another aspect of the present disclosure, a computing apparatus for leveraging language embeddings for time series tasks is provided. The computing apparatus includes a processor; a memory; a display; and a communication interface coupled to each of the processor, the memory, and the display. The processor may be configured to: receive time series data; generate a standardized time series by formatting the time series data into a standard format; generate text embeddings from the standardized time series by transforming a sample of the time series into an embedding; generate a combined representation by combining the generated text embeddings with the standardized time series; pair a classification head framework with the combined representation; and generate a vector representation of time series probabilities based on the pairing of the combined representation with the classification head framework. The classification head framework may comprise a CNN and an MLP.

The processor may be further configured to apply at least one of an AI model and an ML model to embed the formatted time series into an embedding space. The transforming of the sample of the time series into the embedding may be based on a dimension and a length of the sample of the time series.

The processor may be further configured to identify, using the classification head framework and the at least one of the AI model and the ML model, a class label for each time series from within the time series data.

The processor may be further configured to: apply an element-wise addition of the generated text embeddings with the standardized time series to combine the generated text embeddings with the standardized time series. Lengths of the generated text embeddings and lengths of the standardized time series may be aligned prior to the element-wise addition.

The processor may be further configured to: pair the CNN with the combined representation, flatten output from the pairing of the CNN with the combined representation, and then apply the MLP to the flattened output to generate the vector representation of time series probabilities.

The processor may be further configured to: apply a digit-space tokenization method to format the time series data. The digit-space tokenization method may comprise spacing each digit of the time series data, adding commas to separate time steps, and removing decimal points.

The processor may be further configured to: normalize the time series data within a range between zero (0.0) and one (1.0) to standardize the time series.

The classification head framework may identify and separate different classes of the time series data from within the combined representation.

According to yet another aspect of the present disclosure, a non-transitory computer readable storage medium storing instructions for leveraging language embeddings for time series tasks is provided. The storage medium includes executable code which, when executed by a processor, causes the processor to: receive time series data; generate a standardized time series by formatting the time series data into a standard format; generate text embeddings from the standardized time series by transforming a sample of the time series into an embedding; generate a combined representation by combining the generated text embeddings with the standardized time series; pair a classification head framework with the combined representation; and generate a vector representation of time series probabilities based on the pairing of the combined representation with the classification head framework. The classification head framework may comprise a CNN and an MLP.

The storage medium may be further configured to cause the processor to apply at least one of an AI model and an ML model to embed the formatted time series into an embedding space. The transforming of the sample of the time series into the embedding may be based on a dimension and a length of the sample of the time series.

The storage medium may be further configured to cause the processor to identify, using the classification head framework and the at least one of the AI model and the ML model, a class label for each time series from within the time series data.

The storage medium may be further configured to cause the processor to apply an element-wise addition of the generated text embeddings with the standardized time series to combine the generated text embeddings with the standardized time series. Lengths of the generated text embeddings and lengths of the standardized time series may be aligned prior to the element-wise addition.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for utilizing a language embedding model to embed time series and then pairing the embeddings with a classification head for achieving high-performance and efficient time series classification.

FIG. 2 illustrates a diagram of a network environment for utilizing a language embedding model to embed time series and then pairing the embeddings with a classification head for achieving high-performance and efficient time series classification.

FIG. 3 illustrates a system diagram of a system for utilizing a language embedding model to embed time series and then pairing the embeddings with a classification head for achieving high-performance and efficient time series classification.

FIG. 4 illustrates a process diagram of a process for utilizing a language embedding model to embed time series and then pairing the embeddings with a classification head for achieving high-performance and efficient time series classification.

FIG. 5 illustrates a flow diagram of a process for utilizing a language embedding model to embed time series and then pairing the embeddings with a classification head for achieving high-performance and efficient time series classification.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of the example embodiments may be physically separated into two or more interacting and discrete blocks, units, and/or modules without departing from the scope of the inventive concepts. Further, the blocks, units and/or modules of the example embodiments may be physically combined into more complex blocks, units, and/or modules without departing from the scope of the present disclosure.

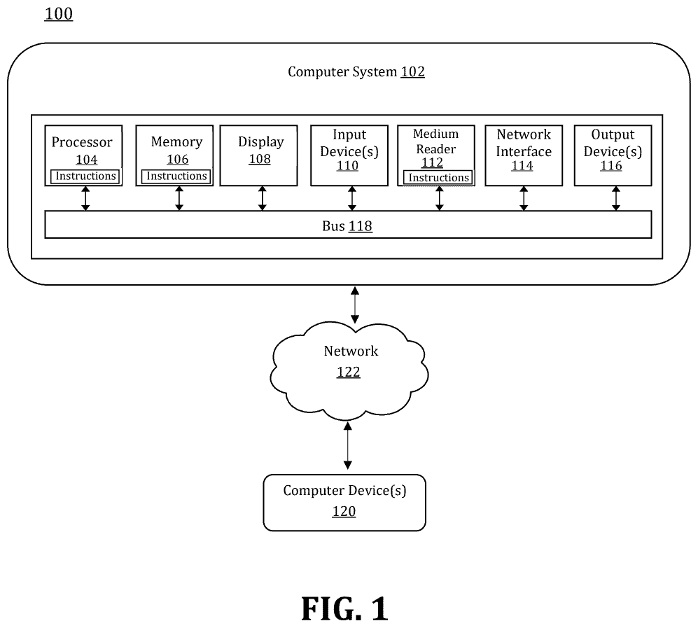

FIG. 1 is a system 100 for utilizing a language embedding model to embed time series and then pairing the embeddings with a classification head for achieving high-performance and efficient time series classification in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In an embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, and serial advanced technology attachment.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the Language Embeddings for Time Series Classification (LETS-C) module implemented by the system 100 may allow for utilizing a language embedding model to embed time series and then pairing the embeddings with a classification head for achieving high-performance and efficient time series classification. The configuration or data files, in some embodiments, may be written using JavaScript Object Notation (JSON), but the disclosure is not limited thereto. For example, the configuration or data files may easily be extended to other readable file formats such as Extensible Markup Language (XML), Yet Another Markup Language (YAML), or any other configuration based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

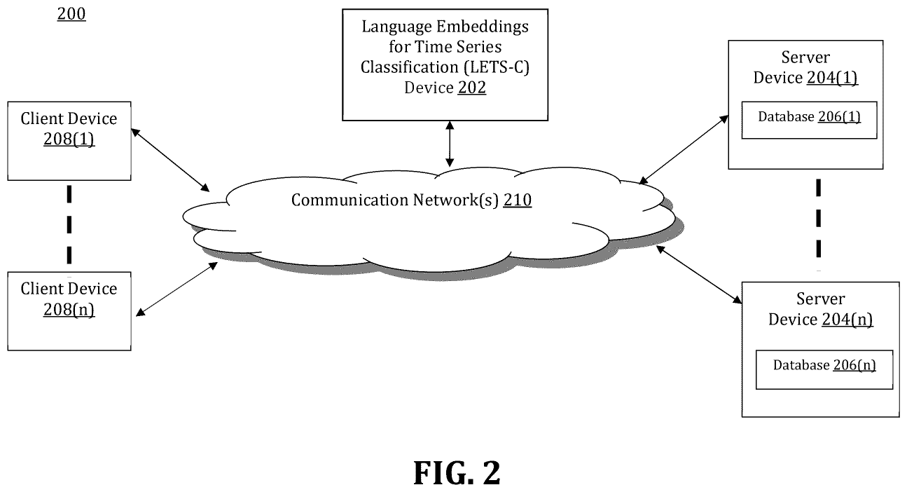

Referring to FIG. 2, a schematic of a network environment 200 for utilizing a language embedding model to embed time series and then pairing the embeddings with a classification head for achieving high-performance and efficient time series classification of the instant disclosure is illustrated.

In some embodiments, the above-described problems associated with conventional tools may be overcome by implementing a LETS-C device 202 as illustrated in FIG. 2 that may be configured for utilizing a language embedding model to embed time series and then pairing the embeddings with a classification head for achieving high-performance and efficient time series classification, but the disclosure is not limited thereto.

The LETS-C device 202 may include one or more computer systems 102, as described with respect to FIG. 1, which in aggregate provide the necessary functions.

The LETS-C device 202 may store one or more applications that can include executable instructions that, when executed by the LETS-C device 202, cause the LETS-C device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the LETS-C device 202 itself, may be located in virtual server(s) running in a cloud-based computing environment rather than being tied to one or more specific physical network computing devices. Also, the application(s) may be running in one or more virtual machines (VMs) executing on the LETS-C device 202. Additionally, in one or more embodiments of this technology, virtual machine(s) running on the LETS-C device 202 may be managed or supervised by a hypervisor.

In the network environment 200 of FIG. 2, the LETS-C device 202 may be coupled to a plurality of server devices 204(1)-204(n) that hosts a plurality of databases 206(1)-206(n), and also to a plurality of client devices 208(1)-208(n) via communication network(s) 210. A communication interface of the LETS-C device 202, such as the network interface 114 of the computer system 102 of FIG. 1, operatively couples and communicates between the LETS-C device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the LETS-C device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use Transmission Control Protocol/Internet Protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The LETS-C device 202 may be a standalone device or integrated with one or more other devices or apparatuses, such as one or more of the server devices 204(1)-204(n), for example. In one example, the LETS-C device 202 may be hosted by one of the server devices 204(1)-204(n), and other arrangements are also possible. Moreover, one or more of the devices of the LETS-C device 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the LETS-C device 202 via the communication network(s) 210 according to the Hypertext Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the LETS-C device 202 that may efficiently provide a platform for utilizing a language embedding model to embed time series and then pairing the embeddings with a classification head for achieving high-performance and efficient time series classification, but the disclosure is not limited thereto.

The client devices 208(1)-208(n) may run interface applications, such as standard web browsers or standalone client applications, which may provide an interface to communicate with the LETS-C device 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the LETS-C device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the LETS-C device 202, the server devices 204(1)-204(n), or the client devices 208(1)-208(n), for example, may be configured to operate as virtual instances on the same physical machine. For example, one or more of the LETS-C devices 202, the server devices 204(1)-204(n), or the client devices 208(1)-208(n) may operate on the same physical device rather than as separate devices communicating through communication network(s) 210. Additionally, there may be more or fewer LETS-C devices 202, server devices 204(1)-204(n), or client devices 208(1)-208(n) than illustrated in FIG. 2. In some embodiments, the LETS-C device 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

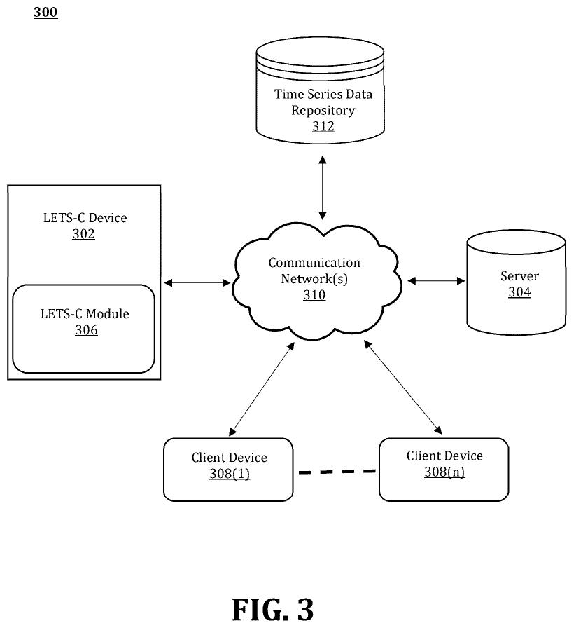

FIG. 3 illustrates a system diagram for utilizing a language embedding model to embed time series and then pairing the embeddings with a classification head for achieving high-performance and efficient time series classification in accordance with an embodiment.

As illustrated in FIG. 3, the system 300 may include a LETS-C device 302 within which a LETS-C module 306 is embedded, a server 304, a time series data repository 312, a plurality of client devices 308(1) . . . 308(n), and a communication network 310.

In some embodiments, the LETS-C device 302 including the LETS-C module 306 may be connected to the server 304, and the database(s) 312 via the communication network 310. The LETS-C device 302 may also be connected to the plurality of client devices 308(1) . . . 308(n) via the communication network 310, but the disclosure is not limited thereto. The time series data repository 312 may include one or more repositories or rule databases.

In an embodiment, the LETS-C device 302 is described and shown in FIG. 3 as including the LETS-C module 306, although it may include other rules, policies, modules, databases, or applications, for example. In some embodiments, the time series data repository 312 may be configured to store ready to use modules written for each Application Programming Interface (API) for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, but the disclosure is not limited thereto. In addition, the time series data repository 312 may store a plurality of time series data sets.

In some embodiments, the LETS-C module 306 may be configured to receive real-time feed of data from the plurality of client devices 308(1) . . . 308(n) and secondary sources via the communication network 310.

The LETS-C module 306 may be configured to: receive time series data; generate a standardized time series by formatting the time series data into a standard format; generate text embeddings from the standardized time series by transforming a sample of the standardized time series into an embedding; generate a combined representation by combining the generated text embeddings with the time series data; pair a classification head framework with the combined representation, wherein the classification head framework comprises a convolutional neural network (CNN) and a multilayer perceptron (MLP); and generate a vector representation of time series probabilities based on the pairing of the combined representation with the classification head framework.

The plurality of client devices 308(1) . . . 308(n) are illustrated as being in communication with the LETS-C device 302. In this regard, the plurality of client devices 308(1) . . . 308(n) may be “clients” (e.g., customers) of the LETS-C device 302 and are described herein as such. Nevertheless, it is to be known and understood that the plurality of client devices 308(1) . . . 308(n) need not necessarily be “clients” of the LETS-C device 302, or any entity described in association therewith herein. Any additional or alternative relationship may exist between either or both plurality of client devices 308(1) . . . 308(n) and the LETS-C device 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the pluralities of client devices 308(1) . . . 308(n) may communicate with the LETS-C device 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The LETS-C device 302 may be the same or similar to the LETS-C device 202 as described with respect to FIG. 2, including any features or combination of features described with respect thereto.

Upon being started, the LETS-C device 302 executes a process for utilizing a language embedding model to embed time series and then pairing the embeddings with a classification head for achieving high-performance and efficient time series classification.

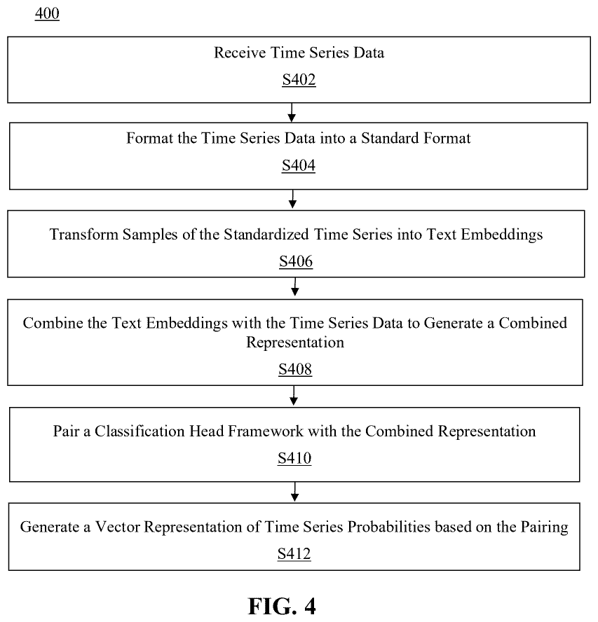

Referring to FIG. 4, a process 400 for utilizing a language embedding model to embed time series and then pairing the embeddings with a classification head for achieving high-performance and efficient time series classification is illustrated, according to an embodiment.

In process 400 of FIG. 4, at step S402, the LETS-C device 302 may receive time series data. The time series data may be from various different domains. For example, in some embodiments, the time series data may relate to: ethanol concentration; face detection; handwriting; heartbeat; vowel frequencies; freeway car lane occupancies; gesture recognition data; and/or any other suitable type of time series.

At step S404, the LETS-C device 302 may format the time series data into a standard format. In an embodiment, the time series data may be formatted by normalizing the time series data within a range between zero (0.0) and one (1.0). In some embodiments, the formatting of the time series data may include applying a digit-space tokenization method that spaces each digit of the time series data, adds commas to separate time steps, and removes the decimal points.

At step S406, the LETS-C device 302 may transform samples of the standardized time series into text embeddings. In an embodiment, the generating of the text embeddings may include applying at least one of an AI model and a ML model to embed the formatted time series into an embedding space. Additionally, the transforming of the sample of the standardized time series into the embedding may be based on a dimension and a length of the sample of the standardized time series.

At step S408, the LETS-C device 302 may combine the text embeddings with the time series data to generate a combined representation. In some embodiments, element-wise addition of the generated text embeddings with the time series data may be used to generate the combined representation. In an embodiment, lengths of the generated text embeddings and lengths of the time series data may be aligned prior to the element-wise addition.

At step S410, the LETS-C device 302 may pair a classification head framework with the combined representation. In some embodiments, the classification head framework includes a CNN and an MLP. In an embodiment, the pairing of the classification head framework with the combined representation may include pairing a CNN with the combined representation, flattening outputs from the pairing of the CNN with the combined representation, and then applying the MLP to the flattened output. In some embodiments, the classification head framework may identify and separate different classes of the time series data from within the combined representation.

Then, at step S412, the LETS-C device 302 may generate a vector representation of time series probabilities based on the pairing of the classification head framework with the combined representation. In an embodiment, the vector representation of time series probabilities may be a vector of probabilities for each time series class.

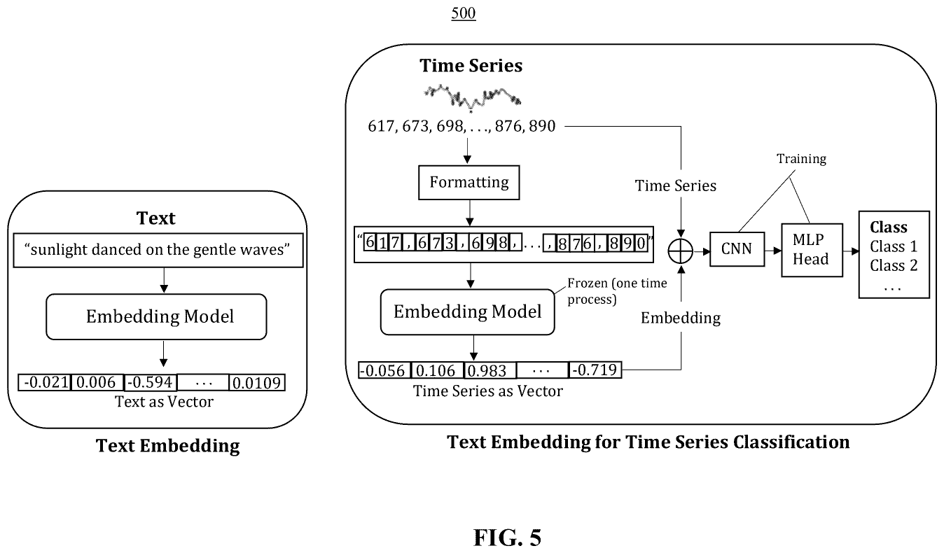

FIG. 5 illustrates a flow diagram of a process for utilizing a language embedding model to embed time series and then pairing the embeddings with a classification head for achieving high-performance and efficient time series classification, according to an embodiment. Specifically, the left-hand side of FIG. 5 illustrates a conventional text embedding system, and the right-hand side shows the LETS-C framework, according to an embodiment. For example, as illustrated in the FIG. 5, the LETS-C framework may normalize time series and format them to tokenize each digit separately. The LETS-C framework may then embed the time series into the embedding space, fuse the embeddings and time series together via element-wise addition, and employ a simple classification head consisting of a CNN and an MLP for classification. In this framework, the lightweight CNN model and the MLP head may be the only trained elements.

In an embodiment, the LETS-C device 302 may combine language embeddings with a simple yet effective classification head that may be any general lightweight ML/deep learning prediction head that may be selected based on the downstream tasks. In an embodiment, the classification head may be composed of CNNs and an MLP. The LETS-C device 302 may project time series data using language embedding models to capture intricate patterns and dependencies present in the temporal data. The embeddings and time series may then be fed into the classification head, which learns to discriminate between different classes. The LETS-C device 302 was tested on a standard benchmark containing 10 datasets across various domains and outperformed twenty baselines including the previous SOTA method. Moreover, the LETS-C device 302 is significantly more efficient, using much less trainable parameters than the previous SOTA method.

In an embodiment, the LETS-C device 302 may leverage language embeddings (or text embeddings) for time series analysis, and the embeddings may be used for multiple downstream time series tasks. In some embodiments, the time series tasks may include classification tasks. The LETS-C device 302 may also achieve SOTA performance in classification accuracy on a well-established benchmark containing 10 datasets across different domains, surpassing 20 baselines. Moreover, the LETS-C device 302 may be significantly more efficient, achieving higher accuracy with much fewer trainable parameters (e.g., 14.5%) compared to the existing SOTA method. Additionally, the LETS-C device 302 was tested with different text embedding models and consistently outperformed previous SOTA with much fewer trainable parameters. These improvements demonstrate the advantage of text embeddings on time series by proving that the embeddings of time series from the same class are more similar than the ones from different classes, which explains the improvement in classification accuracy. Moreover, in an embodiment, the LETS-C device 302 retains a high percentage of accuracy even when the model size shrinks considerably, making it even more computationally efficient without compromising on model accuracy.

In an embodiment, given a time series classification dataset

$$D = \{ {( {x}_{i} , {y}_{j} )}_{i = 1}^{N} \} ,$$

where xᵢ is a multivariate time series sample, and yᵢ∈{1, 2, . . . C} is the corresponding class label, the LETS-C device 302 may learn a classifier that accurately predicts the class label y\hat{ }ᵢ for each time series. The LETS-C device 302 may harness text embeddings for time series classification tasks. Specifically, the LETS-C device 302 may: 1) initially preprocess the time series data to standardize it; 2) subsequently generate text embeddings from the standardized time series; 3) fuse embeddings with the time series data; and 4) feed the fused representation to a classification head that consists of CNNs and an MLP.

In an embodiment, the LETS-C device 302 may min-max normalize each feature dimension of time series xᵢ to the range [0, 1] based on the minimum and maximum feature values of each dimension across the training data to ensure consistent scales across all model inputs.

In some embodiments, the LETS-C device 302 may format the preprocessed time series into strings before using text embeddings, as the tokenization of numerical strings can significantly affect the embeddings. For example, tokenization may impact a model's arithmetic abilities, with commonly used subword tokenization methods like Byte Pair Encoding (BPE) arbitrarily subdividing numbers, causing similar numbers to appear very differently. To mitigate this, the LETS-C device 302 may utilize a digit-space tokenization strategy, where each digit is spaced, commas are added to separate time steps, and decimal points are omitted for fixed precision. For instance, a series with a precision of two decimal places, such as 0.645, 6.45, 64.5, 645.0, would be formatted as “6 4, 6 4 5, 6 4 5 0, 6 4 5 0 0” prior to tokenization. This method may ensure separate tokenization of each digit, preserving numerical integrity and enhancing pattern recognition in language models.

In an embodiment, the LETS-C device 302 may utilize an AI-based text-embedding-3-large model to embed the formatted time series into the embedding space. The AI-based text-embedding-3-large model may be effective in a variety of downstream tasks such as text search and sentence similarity. Additionally, the AI-based text-embedding-3-large model may: support a high maximum token length (e.g., 8191); accommodate a variety of time series datasets; and offer a high-dimensional vector space (e.g., 3072 dimensions). This large dimensionality may capture a broad spectrum of temporal features, yet the model may also allow for truncation to reduce dimensions as needed for specific applications without substantial loss of semantic information. Moreover, this capability to truncate dimensions may be particularly advantageous for optimizing computational efficiency while maintaining robust performance in downstream applications, aligning well with our goal of a lightweight framework.

In an embodiment, the LETS-C device 302 may take each dimension of xᵢ and generate the corresponding text embedding. Thus, the LETS-C device 302 may transform xᵢ∈R^{×lx} into embeddings eᵢ∈R^{d×le}, where d is the multivariate dimension, lₓ is the length of the time series, and lₑ is the length of the embedding. Alternatively, each time series may be divided into separate patches where each patch has a corresponding text embedding. In some embodiments, the embedding computation in LETS-C is a one-time pass, contrasting with the persistent computational cost by other models (e.g., OneFitsAll) which rely on partially frozen transformer-based components. The cosine similarities of text embeddings of time series from the same and different classes may be compared to validate that text embeddings are suitable for time series classification. In an embodiment, the LETS-C device 302 had consistently higher intra-class similarity than inter-class based on a cosine similarity comparison. This result highlights the effectiveness of text embeddings in time series tasks.

In an embodiment, the LETS-C device 302 may fuse embeddings with time series. In some embodiments, the LETS-C device 302 may perform an element-wise addition of the embedding to the preprocessed time series, while preserving the maximum length between the two. Specifically, xᵢ∈R^{d×lx} may be added with embeddings eᵢ∈R^{d×le}. If lx and lₑ do not match, then the shorter one may be padded with zeros to align their sizes before addition, resulting in a combined representation in R^{d×max(lx,le)}. The direct addition of embeddings to the time series data may be analogous to the use of positional embeddings in NLP, which enrich the sequence representation with additional structural and contextual information. As a result, the LETS-C device 302 may enable both time series and text embeddings to contribute to the learning process, thereby enhancing the ability to effectively interpret complex temporal patterns.

In some embodiments, the LETS-C device 302 may include a lightweight classification head. In an embodiment, the LETS-C device 302 may include pairing the fused embedding and time series with a simple classification head composed of one dimensional CNNs and an MLP for time series classification. The output from the CNNs may be flattened and fed through the final MLP head, which outputs a vector of the probabilities of each time series class. In an embodiment, a hyperparameter search may determine the number of convolutional blocks in the CNNs, the number of linear layers in the MLP, and the use of batch normalization, dropout, activation functions, and pooling operations. The simple classification head may allow the LETS-C device 302 to be lightweight and require much less trainable parameters compared to the existing SOTA methods built on transformers.

Accordingly, with this technology, an optimized process for utilizing a language embedding model to embed time series and then pairing the embeddings with a classification head for achieving high-performance and efficient time series classification is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for leveraging language embeddings for time series tasks, the method being implemented by at least one processor, the method comprising:
receiving, by the at least one processor, time series data;
generating, by the at least one processor, a standardized time series by formatting the time series data into a standard format;
generating, by the at least one processor, text embeddings from the standardized time series by transforming a sample of the standardized time series into an embedding;
generating, by the at least one processor, a combined representation by combining the generated text embeddings with the time series data;
pairing, by the at least one processor, a classification head framework with the combined representation, wherein the classification head framework comprises a convolutional neural network (CNN) and a multilayer perceptron (MLP); and
generating, by the at least one processor, a vector representation of time series probabilities based on the pairing of the combined representation with the classification head framework.

2. The method of claim 1, wherein the generating of the text embeddings comprises applying at least one of an artificial intelligence (AI) model and a machine learning (ML) model to embed the formatted time series into an embedding space, and wherein the transforming of the sample of the standardized time series into the embedding is based on a dimension and a length of the sample of the standardized time series.

3. The method of claim 2, further comprising:
identifying, by the at least one processor using the classification head framework and the at least one of the AI model and the ML model, a class label for each time series from within the time series data.

4. The method of claim 1, wherein the combining of the generated text embeddings with the time series data comprises applying an element-wise addition of the generated text embeddings with the time series data, and wherein lengths of the generated text embeddings and lengths of the time series data are aligned prior to the element-wise addition.

5. The method of claim 1, wherein the pairing of the classification head framework with the combined representation comprises pairing the CNN with the combined representation, flattening output from the pairing of the CNN with the combined representation, and then applying the MLP to the flattened output.

6. The method of claim 1, wherein the formatting of the time series data further comprises applying a digit-space tokenization method, and wherein the digit-space tokenization method comprises spacing each digit of the time series data, adding commas to separate time steps, and removing decimal points.

7. The method of claim 1, wherein the generating of the standardized time series comprises normalizing the time series data within a range between zero (0.0) and one (1.0).

8. The method of claim 1, wherein the classification head framework identifies and separates different classes of the time series data from within the combined representation.

9. A computing apparatus for leveraging language embeddings for time series tasks, the computing apparatus comprising:
a processor;
a memory;
a communication interface coupled to each of the processor and the memory, wherein the processor is configured to:
receive time series data;
generate a standardized time series by formatting the time series data into a standard format;
generate text embeddings from the standardized time series by transforming a sample of the standardized time series into an embedding;
generate a combined representation by combining the generated text embeddings with the time series data;
pair a classification head framework with the combined representation, wherein the classification head framework comprises a convolutional neural network (CNN) and a multilayer perceptron (MLP); and
generate a vector representation of time series probabilities based on the pairing of the combined representation with the classification head framework.

10. The computing apparatus of claim 9, wherein the processor is further configured to:
apply at least one of an artificial intelligence (AI) model and a machine learning (ML) model to embed the formatted time series into an embedding space, and wherein the transforming of the sample of the standardized time series into the embedding is based on a dimension and a length of the sample of the standardized time series.

11. The computing apparatus of claim 10, wherein the processor is further configured to:
identify, using the classification head framework and the at least one of the AI model and the ML model, a class label for each time series from within the time series data.

12. The computing apparatus of claim 9, wherein the processor is further configured to:
apply an element-wise addition of the generated text embeddings with the time series data to combine the generated text embeddings with the time series data, and wherein lengths of the generated text embeddings and lengths of the time series data are aligned prior to the element-wise addition.

13. The computing apparatus of claim 9, wherein the processor is further configured to:
pair the CNN with the combined representation, flatten output from the pairing of the CNN with the combined representation, and then apply the MLP to the flattened output to generate the vector representation of time series probabilities.

14. The computing apparatus of claim 9, wherein the processor is further configured to:
apply a digit-space tokenization method to format the time series data, wherein the digit-space tokenization method comprises spacing each digit of the time series data, adding commas to separate time steps, and removing decimal points.

15. The computing apparatus of claim 9, wherein the processor is further configured to:
normalize the time series data within a range between zero (0.0) and one (1.0) to standardize the time series.

16. The computing apparatus of claim 9, wherein the classification head framework identifies and separates different classes of the time series data from within the combined representation.

17. A non-transitory computer readable storage medium storing instructions for leveraging language embeddings for time series tasks, the storage medium comprising executable code which, when executed by a processor, causes the processor to:
receive time series data;
generate a standardized time series by formatting the time series data into a standard format;
generate text embeddings from the standardized time series by transforming a sample of the standardized time series into an embedding;
generate a combined representation by combining the generated text embeddings with the time series data;
pair a classification head framework with the combined representation, wherein the classification head framework comprises a convolutional neural network (CNN) and a multilayer perceptron (MLP); and
generate a vector representation of time series probabilities based on the pairing of the combined representation with the classification head framework.

18. The storage medium of claim 17, wherein when executed by the processor, the executable code further causes the processor to:
apply at least one of an artificial intelligence (AI) model and a machine learning (ML) model to embed the formatted time series into an embedding space, and wherein the transforming of the sample of the standardized time series into the embedding is based on a dimension and a length of the sample of the standardized time series.

19. The storage medium of claim 17, wherein when executed by the processor, the executable code further causes the processor to:
identify, using the classification head framework and the at least one of the AI model and the ML model, a class label for each time series from within the time series data.

20. The storage medium of claim 17, wherein when executed by the processor, the executable code further causes the processor to:
apply an element-wise addition of the generated text embeddings with the time series data to combine the generated text embeddings with the time series data, and wherein lengths of the generated text embeddings and lengths of the time series data are aligned prior to the element-wise addition.
